(19) United States
(12) Patent Application Publication
(10) Pub. No.: US 2025/0038456 A1
(43) Pub. Date: Jan. 30, 2025

(54) CONNECTOR AND CONNECTOR ASSEMBLY

(71) Applicant: SUMITOMO WIRING SYSTEMS, LTD., Mie (JP)

(72) Inventors: Sho KOBAYASHI, Mie (JP); Takahiro KIKUCHI, Mie (JP); Toshihiro ITO, Mie (JP); Tsuyoshi MASE, Mie (JP); Yoichi TAKAGI, Mie (JP); Toya TAICHI, Mie (JP)

(21) Appl. No.: 18/765,828

(22) Filed: Jul. 8, 2024

(30) Foreign Application Priority Data
Jul. 24, 2023 (JP) 2023-119850

(51) Int. Cl. H01R 13/629

(52) U.S. Cl. CPC H01R 13/6295; H01R 13/62938

(57) ABSTRACT

A connector of the present disclosure includes a housing, a detecting member displaceable or pushable forward from a standby position to a detection position, and a cover mounted on a rear end part of the housing. The cover includes a cover lock portion, a vertical portion provided on a rear end of the cover lock portion and a tapered portion continuous from the vertical portion. A rear end of the detecting member at the standby position is disposed at a position behind the vertical portion and along the tapered portion.

### CROSS-REFERENCE TO RELATED APPLICATIONS

This application is based on and claims priority from Japanese Patent Application No. 2023-119850, filed on Jul. 24, 2023, with the Japan Patent Office, the disclosure of which is incorporated herein in its entirety by reference.

### TECHNICAL FIELD

The present disclosure relates to a connector and to a corresponding connector assembly.

### BACKGROUND

A female connector described in Japanese Patent Laid-open Publication No. 2022-032086 is known as a connector provided with a connection detecting member. This female connector is provided with a female housing for accommodating female terminals (not shown) inside and a connection detecting member for detecting a connected state. The female housing includes a CPA accommodating portion for accommodating the connection detecting member. The CPA accommodating portion has a bottom wall and a pair of protection walls extending perpendicularly from both end sides of the bottom wall. The connection detecting member includes an operating portion serving as a body. By pushing the operating portion with a finger, the connection detecting member is slid from a temporary locking position to a complete locking position and it is detected that a male connector and the female connector are in a connected state.

### SUMMARY

However, since the pair of protection walls are arranged on both left and right sides of the operating portion and the bottom wall is arranged below the operating portion in the above connector, it is difficult to bring a finger into contact with the operating portion. For example, it is extremely difficult to bring the finger into contact with the operating portion in an environment where the connector cannot be directly seen by the eyes.

Accordingly, it is an object of the present invention to improve operability of a connector and connector assembly.

This object is solved according to the invention by the features of the independent claims. Particular embodiments of the invention are subject of the dependent claims.

According to one aspect of the invention, there is provided a connector, comprising: a housing; a detecting member including a operating portion, the detecting member being movable from a standby position to a detection position with respect to the housing by the operating portion being displaced substantially forward; and a cover to be mounted the housing, the cover including at least one cover lock portion, a vertical portion provided on a distal end of the cover lock portion and a tapered portion substantially continuous from the vertical portion, and a rear end of the detecting member at the standby position being disposed at a position behind the vertical portion and substantially along the tapered portion.

According to a particular embodiment, there is provided a connector with a housing, a detecting member including a push-in portion, the detecting member being movable from a standby position to a detection position with respect to the housing by the push-in portion being pushed in forward, and a cover mounted on a rear end part of the housing, the cover including a cover lock portion, a vertical portion provided on a rear end of the cover lock portion and a tapered portion continuous from the vertical portion, and a rear end of the detecting member at the standby position being disposed at a position behind the vertical portion and along the tapered portion.

In displacing or moving (e.g. pushing) the detecting member from the standby position to the detection position, e.g. a finger can be brought into contact with the rear end of the detecting member by placing the finger on the tapered portion of the cover and moving the finger along the tapered portion. Once the finger contacts the rear end of the detecting member, the finger can be moved to the operating portion (e.g. the push-in portion) by sliding from there. By doing so, the position of the detecting member can be correctly grasped and the operating portion (e.g. the push-in portion) can be displaced (e.g. pushed in) forward, for example, in an environment where the connector cannot be directly seen by the eyes. Thus, the operability of the detecting member and overall of the connector can be improved.

Particularly, the detecting member includes at least one detection arm and the operating portion (particularly the push-in portion) coupled to a rear end part of the detection arm, the operating portion (e.g. the push-in portion) having at least one push-in surface.

Further particularly, at least one push-in enlarged surface substantially continuous with the push-in surface is formed on or near a corner part facing the tapered portion, out of the operating portion (e.g. the push-in portion).

Since the finger particularly contacts the push-in enlarged surface by being moved along the tapered portion, the finger is easily brought into contact with the detecting member. Thereafter, the detecting member can be pushed in forward by moving the finger from the push-in enlarged surface to the push-in surface.

Further particularly, the operating portion (e.g. the push-in portion) has an oblong or long shape in a width direction, and a pair of protruding portions are formed to obliquely extend further rearward than the push-in surface on or near both end parts in the width direction of the operating portion (e.g. the push-in portion).

Since fingers can be hooked on the protruding portions in pulling out the detecting member from the detection position to the standby position, an operation of pulling out the detecting member can be easily performed.

Further particularly, at least one locking projection is formed at a position at or near a front end part of the detection arm engageable with at least one locking portion of the housing, so that the detecting member particularly is held at the standby position and a movement thereof to the detection position is suppressed.

Further particularly, wherein the detection arm comprises at least one temporary locking portion displaced from the locking projection on the detection arm so as to be lockable to at least one temporary locking projection of the housing, so that the detecting member particularly is holdable at the standby position while being prevented from being displaced away from the housing.

Further particularly, the connector further comprises a movable member (such as a lever) movably or displaceably (particularly rotatably or pivotably) arranged on the housing between an initial position and a completion position, so as to display a cam action for assisting a connection and/or separation of the connector and a mating connector.

Further particularly, the housing comprises a lock arm movably provided thereon, wherein the lock arm has at least one lock receiving portion lockable to at least one lock portion of the movable member so as to hold the movable member at the completion position.

Further particularly, the lock arm includes a base end portion connected to a housing body portion of the housing, an arm portion substantially extending rearward from the base end portion and the at least one lock receiving portion formed on or near a rear end part of the arm portion.

According to another aspect, there is provided a connector assembly comprising a connector according to the above aspect or a particular embodiment thereof and a mating connector connectable therewith.

According to the above, the operability of a detecting member can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector with a lever located at an initial position when viewed obliquely from front.

FIG. 2 is a side view of the connector with the lever located at the initial position.

FIG. 3 is a side view of the connector with the lever located at a completion position and a detecting member located at a standby position.

FIG. 4 is a side view of the connector with the lever located at the completion position and the detecting member located at a detection position.

FIG. 5 is a side view showing a state where a finger is brought into contact with a push-in enlarged surface of the detecting member while being moving along a tapered portion.

FIG. 6 is a side view showing a state where the detecting member is pushed by bringing the finger into contact with a push-in surface of the detecting member.

FIG. 7 is a perspective view showing a state before a cover is mounted on a rear end part of a housing.

FIG. 8 is a side view of the cover.

FIG. 9 is a section showing a locking structure of the cover and the housing.

FIG. 10 is a plan view showing a state where fingers are hooked on protruding portions of the detecting member at the detection position.

FIG. 11 is a plan view showing a state where a finger is brought into contact with the push-in surface and the push-in enlarged surface of the detecting member.

FIG. 12 is a perspective view of the detecting member when viewed obliquely from below.

FIG. 13 is a section showing a locked state of the detecting member at the standby position.

FIG. 14 is a section showing a locked state of the detecting member at the detection position.

FIG. 15 is a section showing a locked state of a lever lock portion at the standby position of the detecting member.

FIG. 16 is a section showing a locked state of the lever lock portion at the detection position of the detecting member.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

A specific example of a connector of the present disclosure is described below with reference to the drawings. For the convenience of description, some components may be shown in an exaggerated or simplified manner in each drawing. Further, a dimension ratio of each part may be different in each figure. “Parallel”, “perpendicular” and “orthogonal” in this specification mean not only strictly parallel, perpendicular and orthogonal, but also substantially parallel, perpendicular and orthogonal within a range in which functions and effects in the embodiment are achieved.

In each figure, three directions perpendicular to each other are shown and these three directions are respectively shown as a front-rear direction X, a lateral direction Y and a vertical direction Z. That is, the front-rear direction X and the lateral direction Y are perpendicular to each other, the lateral direction Y and the vertical direction Z are perpendicular to each other and the vertical direction Z and the front-rear direction X are perpendicular to each other. The front-rear direction X is based on a connection direction of the connector, and a connection surface side of the connector is referred to as a front side. The lateral direction Y and the vertical direction Z are based on lateral and vertical directions when viewed from the connection surface side.

Further, a term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. Further, the “tubular” shapes include substantially circular shapes, elliptical shapes and polygonal shapes with angular or rounded corners.

Further, a term “ring” in this specification means an arbitrary closed shape having an outer edge connected by straight lines or curves, including a circular ring substantially having a circular outer edge, a ring substantially having an elliptical or oval outer edge, a polygonal ring substantially having a polygonal outer edge and/or a ring substantially having a polygonal outer edge with rounded corners. The “ring” may be shaped such that an outer edge shape and an inner edge shape have the same shape or may be shaped such that an outer edge shape and an inner edge shape are different. The “ring” may have a predetermined length along a center axis direction, and the length does not matter. Further, an “annular shape” in this specification only has to be regarded as a ring as a whole and may include at least one cut, at least one slit or the like in a part such as a C shape.

Further, “facing each other” in this specification indicates that surfaces or members are at positions in front of each other, and means not only a case where the surfaces or members are at positions perfectly in front of each other, but also a case where the surfaces or members are at positions partially substantially in front of each other. Further, “facing each other” in this specification means both a case where another member different from two parts at least partly is interposed between the two parts and a case where nothing is interposed between the two parts.

### EMBODIMENT

### Configuration of Connector 10

A connector 10 is a connector connectable to a mating connector (not shown).

The mating connector particularly is provided with a mating housing (not shown) for holding one or more male terminals (not shown). The mating housing particularly substantially is in the form of a tube open forward. The male terminals particularly are provided to substantially project forward from the back wall of the mating housing.

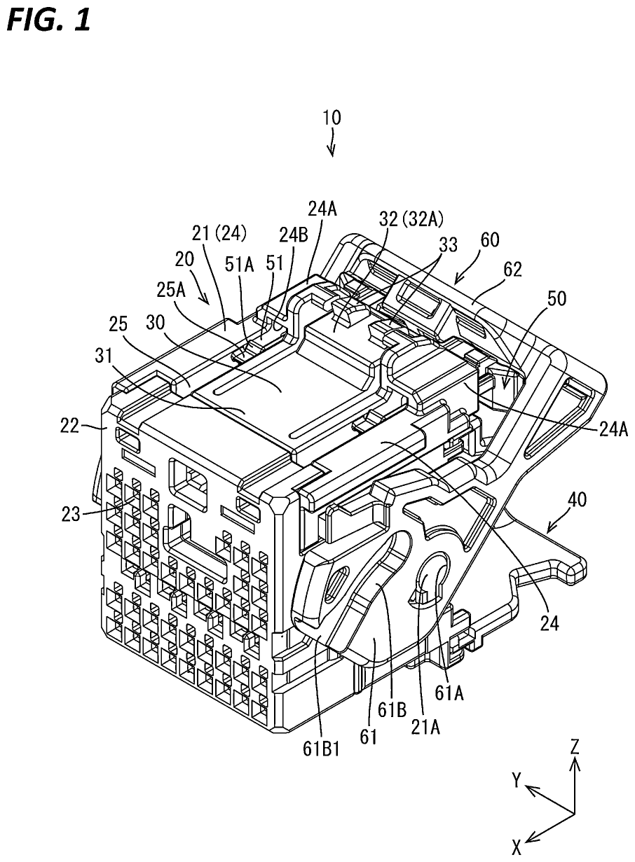

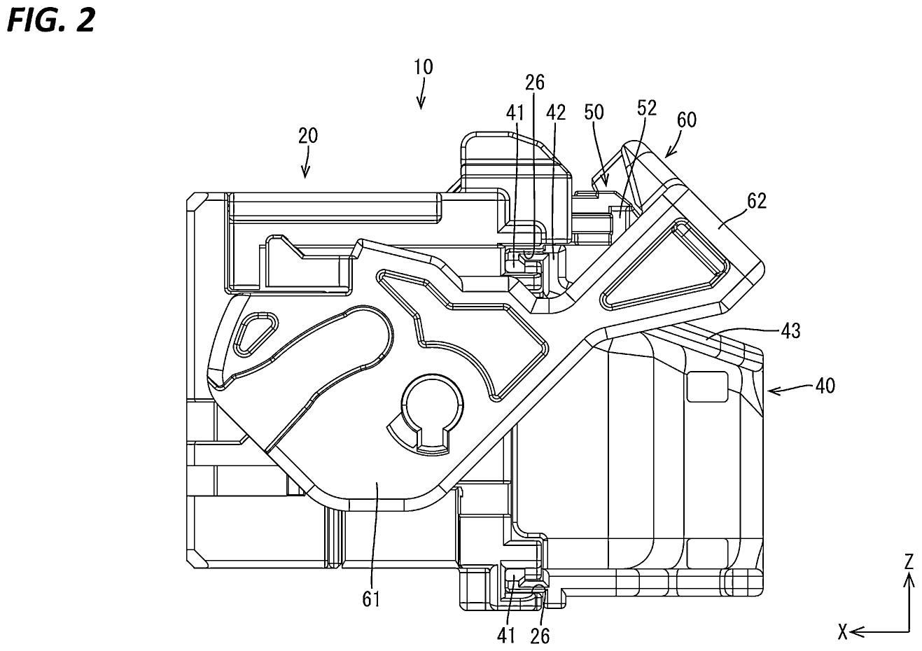

As shown in FIGS. 1 and 2, the connector 10 particularly is provided with a housing 20 including a lock arm 30, a cover 40, a detecting member 50 and/or a lever 60.

Insulating resin materials can be cited as particular materials of the housing 20, the cover 40, the detecting member 50 and/or the lever 60, wherein it is understood that different elements may be made by same, similar or different materials.

### Configuration of Housing 20

As shown in FIG. 1, the housing 20 particularly includes a housing body portion 21 for at least partly accommodating and holding one or more terminal fittings such as female terminal(s) (not shown) to be connected to the respective mating terminal fitting(s) such as male terminal(s) inside and particularly a front holder 22 to be mounted on (particularly a front side of) the housing body portion 21.

Specifically, the front holder 22 substantially is open rearward and/or externally fit to the housing body portion 21 e.g. from front. The front holder 22 particularly is formed with one or more, particularly a plurality of terminal insertion holes 23, through which the mating terminal(s), particularly male terminal(s) at least partly are inserted or insertable.

One or more, particularly a pair of lock protection walls 24 specifically are formed on or near one or both side edges of (particularly an upper side of) the housing body portion 21.

The lock arm 30 particularly is to be arranged adjacent to the lock protection wall(s) 24. Specifically, the lock arm 30 at least partly is formed or arranged between the pair of lock protection walls 24.

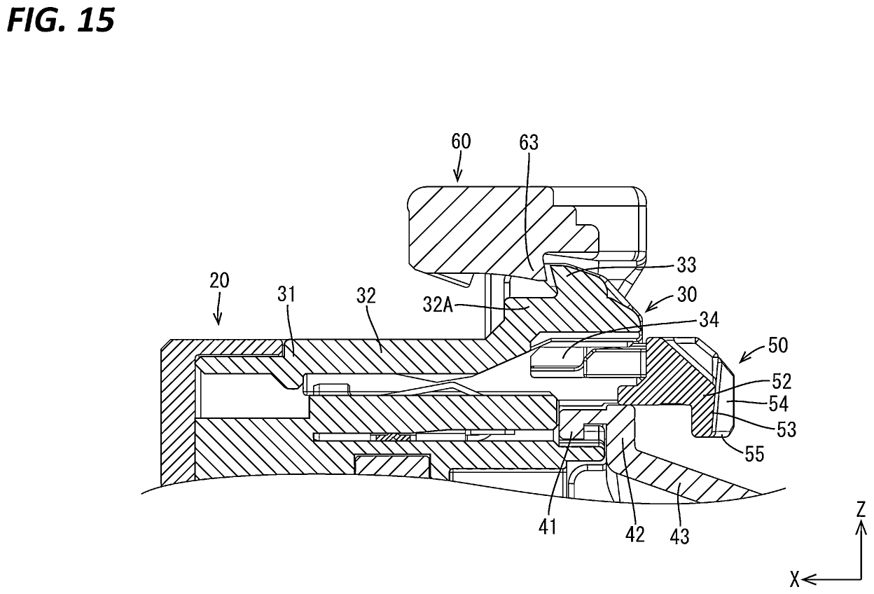

As shown in FIG. 15, the lock arm 30 particularly includes a base end portion 31 connected to (particularly the upper surface of) the housing body portion 21, an arm portion 32 substantially extending rearward from the base end portion 31 and one or more lock receiving portions 33 formed on (particularly a rear end part 32A of) the arm portion 32.

The arm portion 32 particularly is cantilevered or swingable substantially in the vertical direction with the base end portion 31 as a base end.

The one or more lock receiving portions 33 particularly are displaceable toward and away from the housing body portion 21, e.g. substantially in the vertical direction, according to a cantilever or swinging movement of the arm portion 32.

The one or more lock receiving portions 33 particularly are resiliently displaced toward the housing body portion 21, e.g. substantially downward, by at least one lever lock portion 63 to be described later during the displacement (particularly rotation or pivotal movement) of the lever 60 and/or particularly are displaced away from the housing body portion 21, e.g. substantially upward, to return and lockable to the lever lock portion 63 when the displacement (toward and away from the housing body portion 21, e.g. substantially rotation or pivotal movement) of the lever 60 is completed.

As shown in FIG. 1, the rear end part 32A of the arm portion 32 particularly is formed to substantially project upward or outward.

One or more, particularly a pair of the lock receiving portions 33 are provided on the outer or upper surface of the rear end part 32A of the arm portion 32.

One or more mounting portions 24A, adjacent to which the detecting member 50 particularly is mounted or mountable, are formed on or near the rear end part 32A of the arm portion 32. Specifically, a pair of mounting portions 24A, at least partly inside which the detecting member 50 is mounted, are formed on both lateral (left and right) sides of the rear end part 32A of the arm portion 32.

The mounting portion 24A particularly constitutes a part of the lock protection wall 24 and/or is formed on a rear end part of the lock protection wall 24.

### Movable Member such as Lever 60

As shown in FIG. 1, the lever 60 (as a particular movable member) particularly is substantially U-shaped as a whole.

Specifically, the lever 60 is provided with one or more, particularly a pair of (particularly substantially plate-like) portions 61, an operating portion 62 connected to the portion(s) 61, particularly coupling the pair of (substantially plate-like) portions 61 and/or the at least one lever lock portion 63 particularly projecting from the operating portion 62.

The two plate-like portions 61 particularly are disposed to substantially face each other.

The plate-like portion 61 particularly is formed with a shaft hole 61A recessed in or penetrating through the plate-like portion 61 and/or at least one cam groove 61B recessed in a thickness direction (lateral direction) of the (substantially plate-like) portion 61 particularly from the outer surface of the plate-like portion 61.

The cam groove 61B particularly includes an entrance opening 61B1 located in an outer edge part of the (substantially plate-like) portion 61, and extends in a substantially arcuate manner from the entrance opening 61B1 particularly to approach the shaft hole 61A.

The entrance opening 61B1 serves as an opening for at least partly receiving a cam pin (not shown) of the mating connector into the cam groove 61B.

One or more shaft portions 21A are formed on one or more side surfaces of the housing body portion 21. Specifically, one shaft portion 21A is disposed on each of the both side surfaces of the housing body portion 21.

By at least party accommodating the shaft portion(s) 21A into the shaft hole(s) 61A of the lever 60, the lever 60 particularly is rotatably or pivotably supported on the housing 20. It should be understood that the movable member may be displaced along a different path, such as a substantially linear path with respect to the housing 20 in order to display a cam action assisting the connection of the connector with the mating connector.

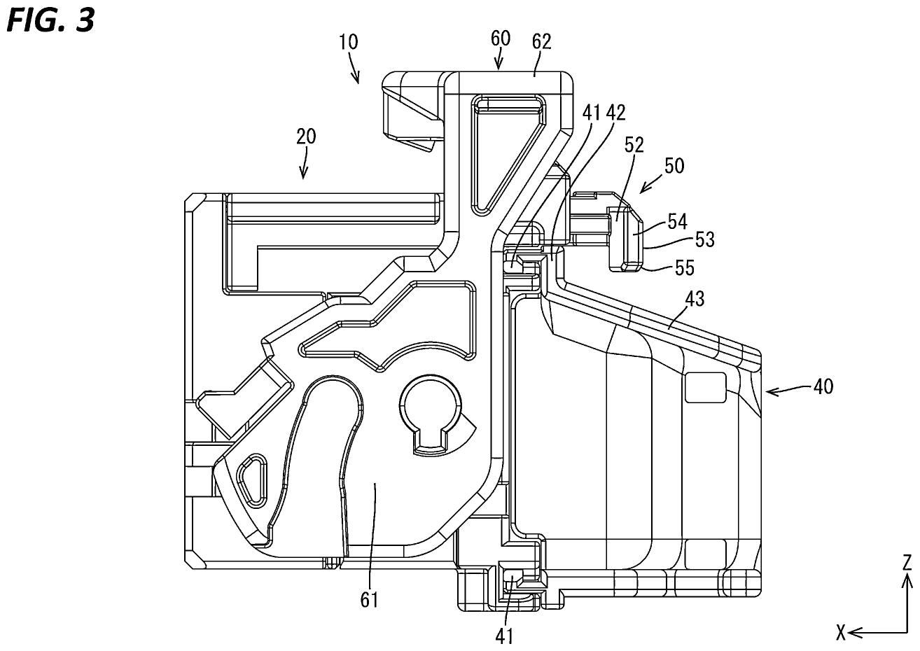

The lever 60 is displaceable (particularly rotatable or pivotable) between an initial position shown in FIG. 2 and a completion position shown in FIG. 3.

As shown in FIGS. 1 and 15, the at least one lever lock portion 63 particularly is formed to substantially project inward (particularly toward the shaft hole(s) 61A) from the inner surface of the operating portion 62.

By locking the lever lock portion(s) 63 to the lock receiving portion(s) 33 of the housing 20, the lever 60 particularly is held or holdable at the completion position and/or the connector 10 and the mating connector particularly are held in a connection completed state.

### Detecting Member 50

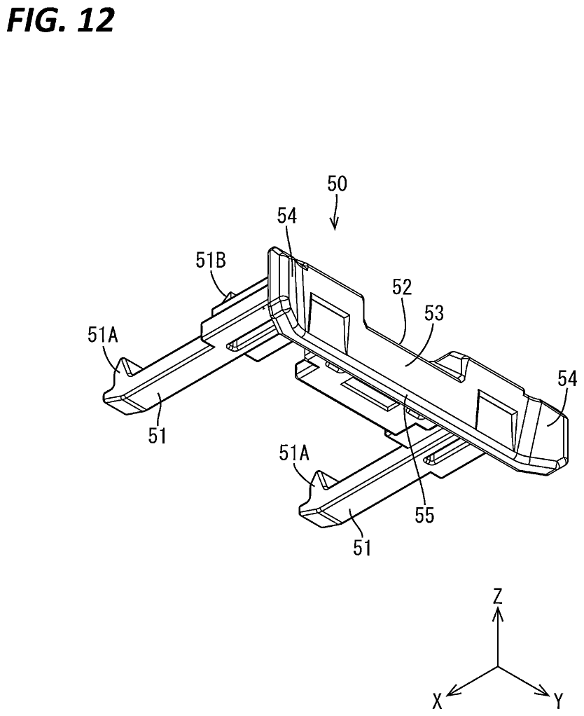

As shown in FIG. 12, the detecting member 50 particularly includes one or more detection arms 51 and an operating portion (such as a push-in portion) 52 coupled to the detection arm(s) 51. Specifically, the detecting member 50 includes a pair of detection arms 51 and the operating portion (e.g. the push-in portion) 52 couples to rear end parts of the pair of detection arms 51.

The push-in portion 52 particularly has a push-in surface 53. The push-in surface 53 specifically is formed on a surface substantially opposite to the detection arm(s) 51, particularly to the pair of detection arms 51, out of the outer surface of the push-in portion 52.

At least one locking projection 51A particularly is formed at a position near a front end part of the detection arm 51. The locking projection 51A particularly has a semi-locking shape (e.g. front and rear inclined surfaces are gently inclined when viewed from the direction Y), and/or substantially projects outward upward from the detection arm 51.

Specifically, the operating portion (e.g. the push-in portion) 52 substantially has a long shape in the lateral direction (Y direction), and one or more, particularly a pair of protruding portions 54 are formed to obliquely extend further rearward than the push-in surface 53 on (particularly one or both end parts in the lateral direction of) the operating portion (push-in portion) 52.

An operating enlarged surface (e.g. a push-in enlarged surface) 55 substantially continuous with the push-in surface 53 particularly is formed on corner part(s) (particularly corner parts substantially facing a tapered portion 43 to be described later) located on (particularly rear parts of lower end sides of) the push-in portion 52 and/or the one or more, particularly the pair of protruding portions 54.

As shown in FIG. 1, the one or more detection arms 51 particularly at least partly are mounted in the one or more mounting portions 24A of the housing 20.

Specifically, the mounting portion 24A includes a mounting hole or recess 24B, into which the detection arm 51 at least partly is inserted or insertable.

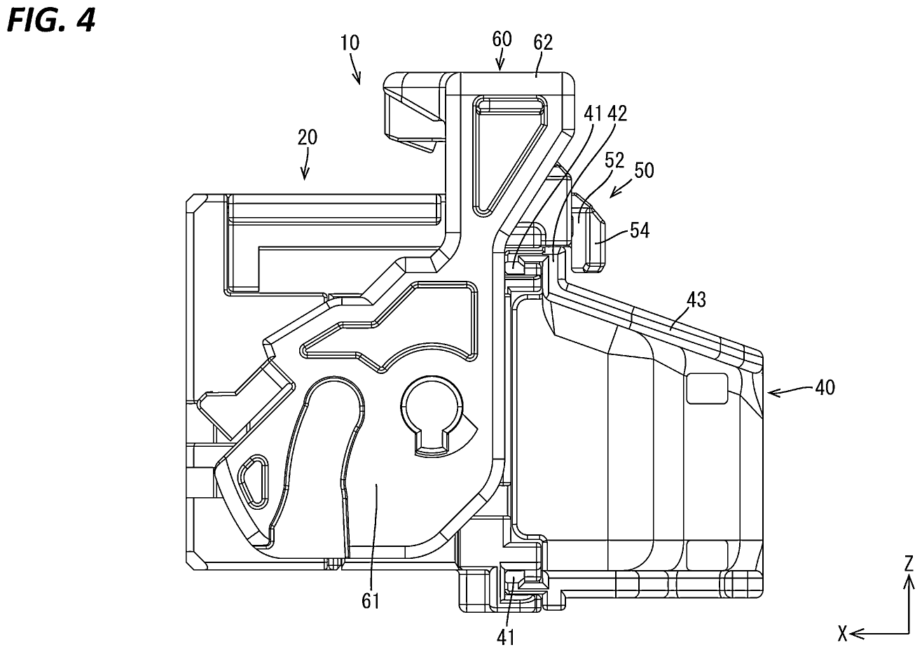

By at least partly inserting the one or more (pair of) detection arms 51 into one or more (a pair of) the mounting holes 24B particularly substantially from behind, the detecting member 50 particularly is movable substantially in the front-rear direction between a standby position shown in FIG. 3 and a detection position shown in FIG. 4.

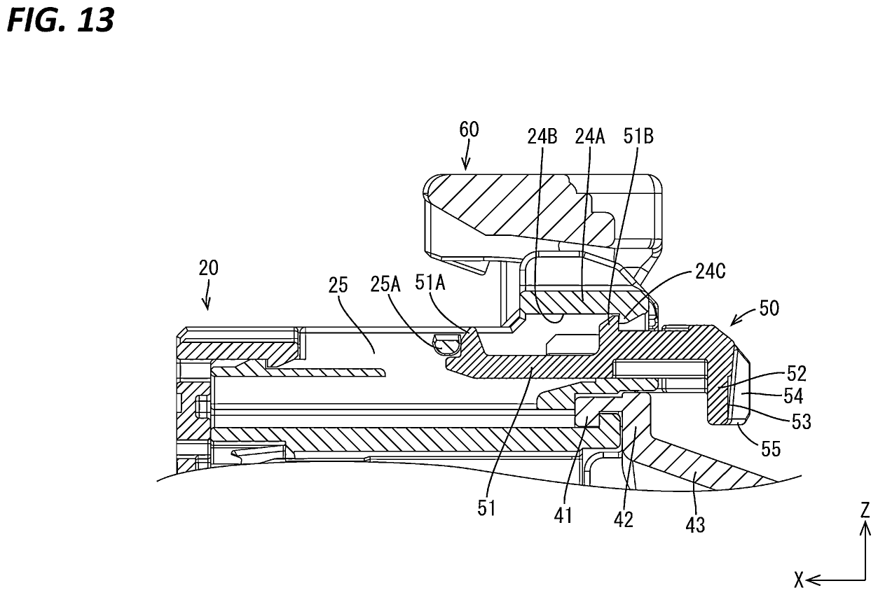

As shown in FIG. 13, at least one temporary locking portion 51B particularly is formed displaced from (e.g. behind) the locking projection 51A on the detection arm 51. The temporary locking portion 51B particularly projects upward or outward from the detection arm 51. A part of the detection arm 51 behind the temporary locking portion 51B is formed with a recess or hole open downward to be thinned.

The temporary locking portion 51B particularly is to be at least partly accommodated inside the mounting hole 24B of the housing 20.

At least one temporary locking projection 24C particularly is formed on (particularly a rear end part of) the upper or outer surface of an inner wall constituting the mounting hole 24B.

The temporary locking projection 24C particularly substantially projects downward from the upper surface of the inner wall of the mounting hole 24B.

By particularly locking the temporary locking portion(s) 51B of the detecting member 50 to the temporary locking projection(s) 24C of the housing 20 e.g. from front, the detecting member 50 is held or holdable at the standby position while being prevented from being displaced e.g. coming out rearward.

As shown in FIG. 1, the detection arm 51 particularly is passed through the mounting hole 24B of the mounting portion 24A and/or at least partly accommodated into a mounting groove 25 formed between the lock arm 30 and the lock protection wall 24.

The mounting groove 25 particularly is formed with at least one locking portion 25A. The locking projection(s) 51A of the detection arm 51 particularly is/are locked to the locking portion(s) 25A from behind. In this way, the detecting member 50 particularly is held at the standby position and a movement thereof to the detection position is suppressed.

As shown in FIG. 13, the front surface of the locking projection 51A of the detection arm 51 particularly is tapered. Thus, if the detecting member 50 is displaced or pushed in forward, the detection arms 51 are resiliently deformed and the locking projection(s) 51A is/are displaced downward.

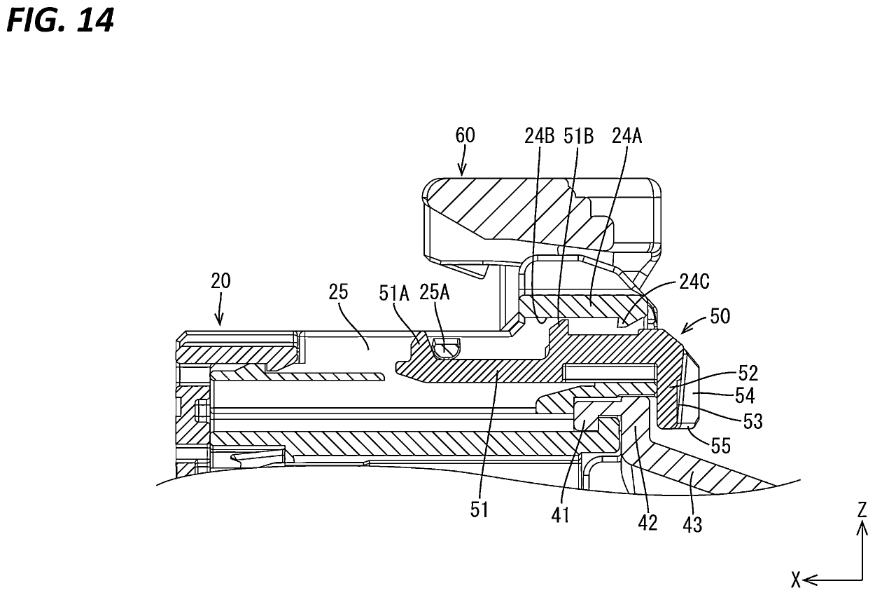

If the detecting member 50 continues to be pushed or displaced in forward, the locking projection(s) 51A particularly pass(es) over the locking portion(s) 25A and/or the detection arm(s) 51 resiliently return(s), whereby the locking projection(s) 51A are locked to the locking portion(s) 25A (particularly from front) as shown in FIG. 14. In this way, the detecting member 50 particularly is held at the detection position and/or a movement thereof to the standby position is suppressed.

As shown in FIG. 15, a deflection space 34, into which the detecting member 50 at least partly can enter from behind, particularly is formed below the lock arm 30.

Since the detecting member 50 particularly is located behind the deflection space 34 when being at the standby position, the lock arm 30 can be deflected downward.

If the lock arm 30 is deflected downward, the locking of the lever lock portion(s) 63 and the lock receiving portion(s) 33 particularly is released, thereby allowing the displacement (particularly rotation or pivotal movement) of the lever 60 towards or to the initial position (i.e. the separation of the connector 10 and the mating connector).

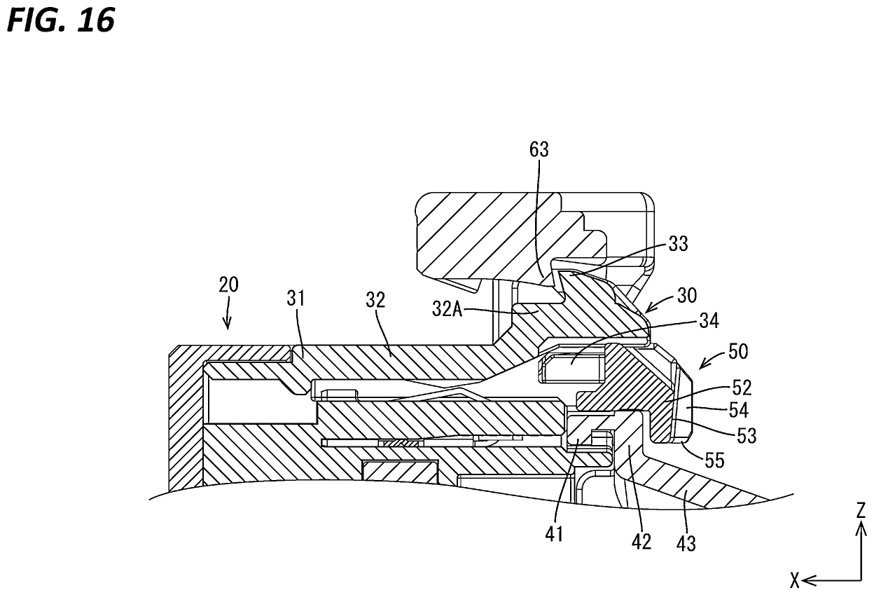

As shown in FIG. 16, since the detecting member 50 particularly at least partly is located in the deflection space 34 when being at the detection position, the lock arm 30 cannot be deflected downward. Thus, the locking of the lever lock portion(s) 63 and the lock receiving portion(s) 33 particularly cannot be released and/or the lever 60 particularly is held at the completion position.

### Cover 40

The cover 40 is mounted or mountable on the housing 20. Specifically, the cover 40 guides one or more wires pulled out (e.g. rearward) from the housing 20 in a predetermined direction and/or protects the wire(s).

Specifically, the cover 40 of this embodiment substantially has a tubular shape as a whole and/or is open rearward and laterally.

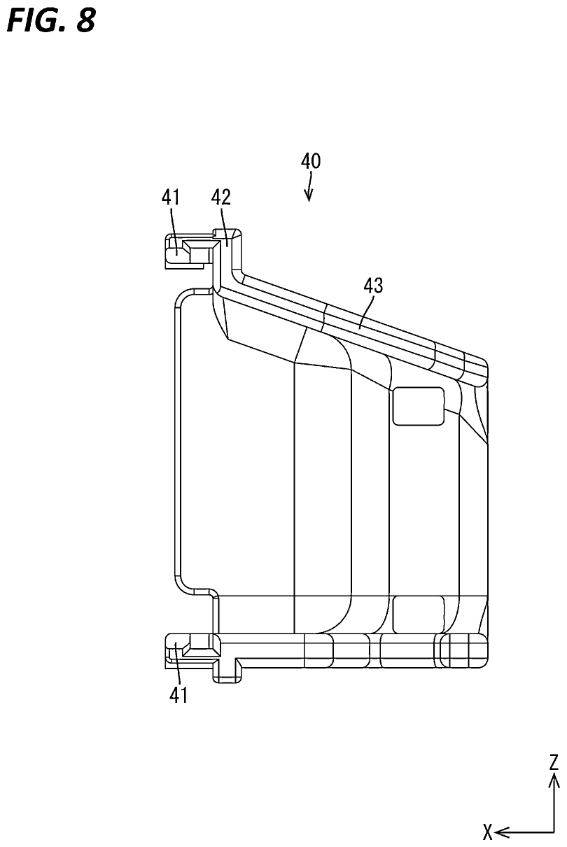

As shown in FIG. 8, the cover 40 includes one or more, particularly a pair of (e.g. upper and lower) cover lock portions 41, a vertical portion 42 provided on (particularly the rear end of) the (e.g. upper) cover lock portion 41 and/or the tapered portion 43 particularly substantially continuous from the vertical portion 42.

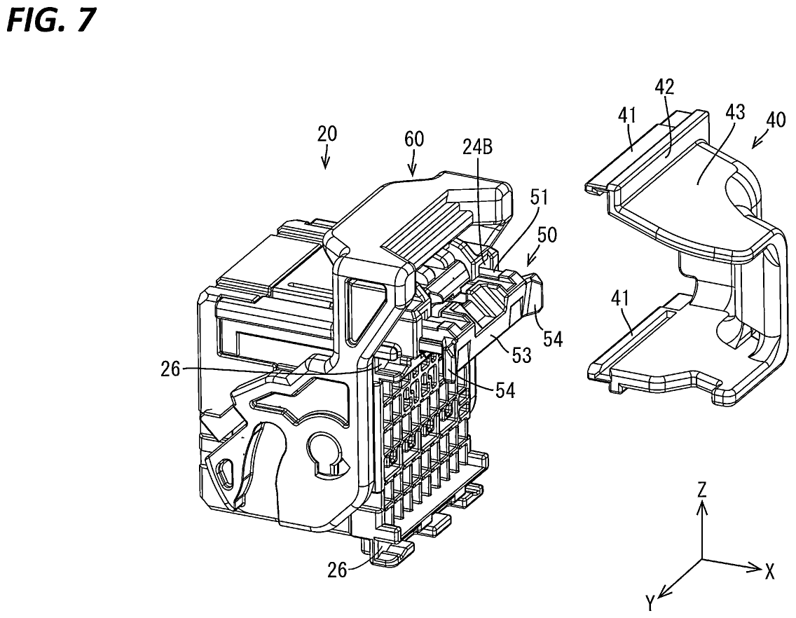

As shown in FIG. 7, the cover lock portion 41 particularly substantially has a long or elongated shape in the lateral direction.

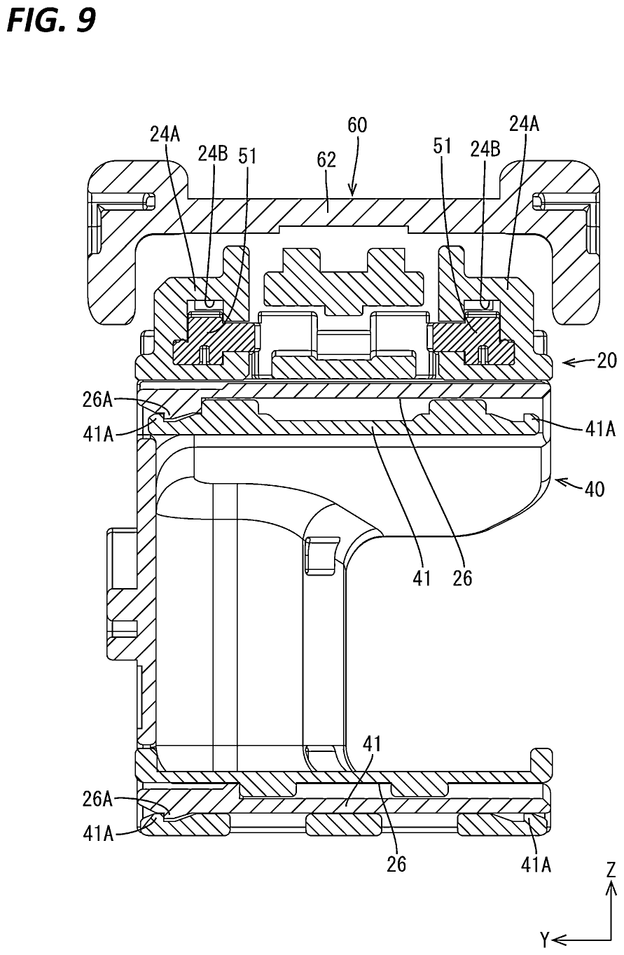

As shown in FIG. 9, one or more, particularly a pair of holding projections 41A particularly are formed on (particularly one or both end parts of) the cover lock portion 41.

On the other hand, the housing 20 particularly is formed with one or more entrance spaces 26, into which the one or more cover lock portions 41 at least partly laterally enter.

An inner wall constituting the entrance space 26 particularly is formed with at least one hold receiving portion 26A to be locked to the holding projection 41A. By locking the holding projection(s) 41A to the hold receiving portion(s) 26A, the cover 40 particularly is held or positioned on the rear end part of the housing 20.

As shown in FIG. 8, the upper cover lock portion 41 particularly substantially projects forward from (particularly the upper end of) the vertical portion 42.

The tapered portion 43 particularly is formed to be tapered downward toward (particularly a rear side from the lower end of) the vertical portion 42.

As shown in FIG. 3, the rear end of the vertical portion 42 particularly is substantially at the same position as the rear end(s) of the mounting portion(s) 24A, into which the detecting member 50 at least partly is mounted or mountable, in the front-rear direction.

The operating portion (e.g. the push-in portion) 52 of the detection arm 50 particularly projects further downward than the detection arm(s) 51. The lower end of the operating portion (push-in portion) 52 particularly substantially is located at the same height as or somewhat below a center of the vertical portion 42 in the vertical direction. That is, the operating portion (e.g. the push-in portion) 52 particularly is located behind the vertical portion 42.

Further, the lower end of the operating portion (e.g. the push-in portion) 52 particularly is disposed at a position along the tapered portion 43.

The push-in enlarged surface 55 of the push-in portion 52 particularly is formed on the corner part facing the tapered portion 43, out of the operating portion (e.g. the push-in portion) 52.

### Operation Method of Detecting Member 50

First, how to particularly mount the detecting member 50 into the housing 20 is described.

As shown in FIG. 9, the one or more, particularly the pair of detection arms 51 at least partly are inserted into the one or more, particularly the pair of mounting holes 24B of the housing 20 e.g. substantially from behind.

As shown in FIG. 13, when the detecting member 50 reaches the standby position, the one or more temporary locking projections 24C particularly are locked to the respective one or more temporary locking portions 51B from front, whereby a rearward movement of the detecting member 50 is suppressed.

Further, the one or more locking projections 51A particularly are locked to the one or more locking portions 25A from behind, whereby a forward movement of the detecting member 50 is suppressed.

After the detecting member 50 is mounted at the standby position in the housing 20, the movable member such as the lever 60 particularly is assembled with the housing 20. Specifically, the movable member such as the lever 60 is assembled with the housing 20 from the side e.g. above (particularly while the pair of plate-like portions 61 are deformed away from each other).

After the movable member such as the lever 40 particularly is held at the completion position and the cover 40 is mounted on the housing 20, the movable member (lever) 60 is set at the initial position.

If the connector 10 and the mating connector are lightly connected, the one or more cam pins of the mating connector at least partly enter the one or more cam grooves 61B of the movable member (e.g. lever) 60. If the movable member is displaced, e.g. the lever 60 is rotated or pivoted, from the initial position to the completion position, the cam pin(s) move along the cam groove(s) 61B, whereby the connection of the connector 10 and the mating connector proceeds by a cam action. If the movable member (e.g. lever) 60 reaches the completion position, the connection of the connector 10 and the mating connector is completed and the one or more terminals respectively of the both are conductively connected.

Subsequently, the detecting member 50 serving as a particular connection assurance member particularly is moved from the standby position to the detection position.

An operation of moving the detecting member 50 is possibly performed in an environment where the detecting member 50 cannot be directly seen by the eyes of an operator, e.g. in a state where the connector 10 is hidden behind another member and e.g. only the hand is inserted to the back side of the other member. In such a case, it is thought to be extremely difficult to bring a finger into contact with the operating portion (e.g. the push-in portion) 52 of the detecting member 50.

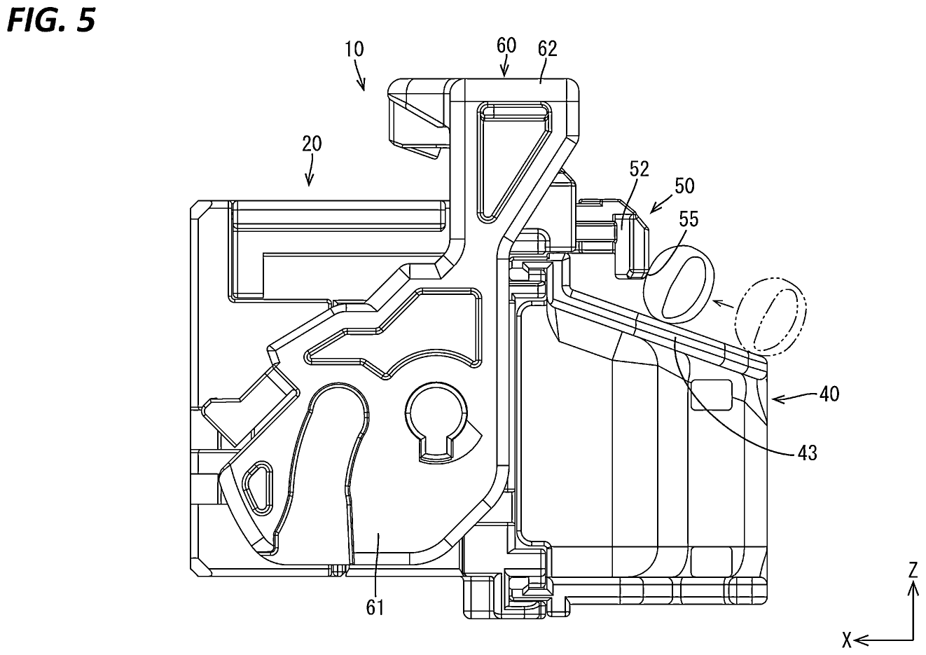

Accordingly, in this embodiment, the finger particularly is placed or placeable on the tapered portion 43 and moved or movable along the tapered portion 43 as shown in FIG. 5, whereby the finger can be reliably brought into contact with the operating portion (e.g. the push-in portion) 52 of the detecting member 50. Particularly, in this embodiment, a ball part of the finger contacts the push-in enlarged surface 55 of the push-in portion 52. In this way, the finger is very easily brought into contact with the operating portion (e.g. the push-in portion) 52 of the detecting member 50.

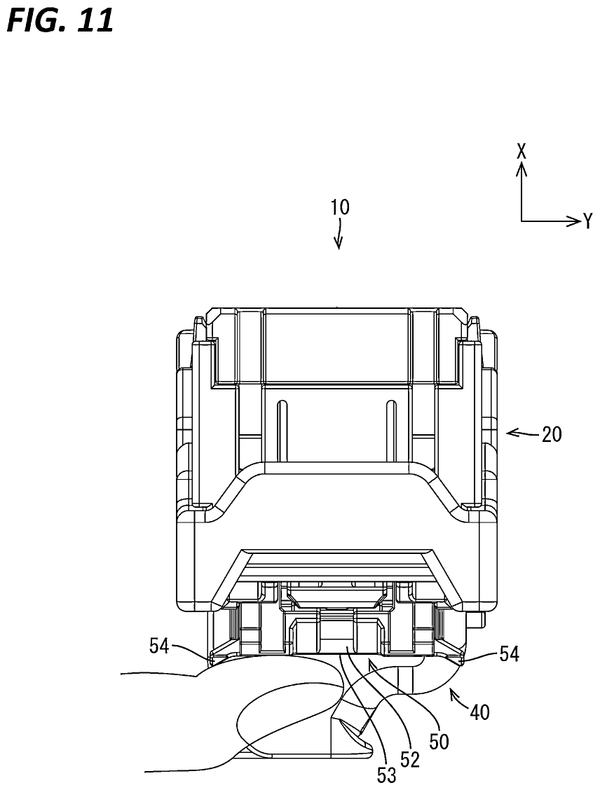

Subsequently, (e.g. the ball part of) the finger is or can be moved to the vicinity of a center of the push-in surface 53 by sliding the finger e.g. somewhat upward. At this time, since (e.g. the ball part of) the finger particularly can be hooked on the protruding portion 54 as shown in FIG. 11, the finger can be firmly brought into contact with the push-in surface 53.

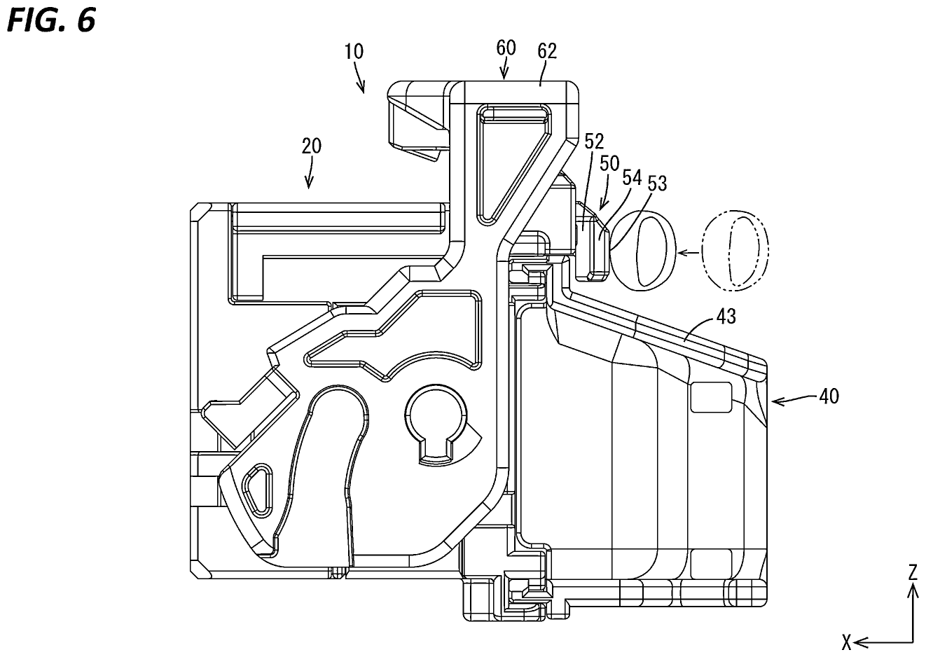

Then, as shown in FIG. 6, the detecting member 50 particularly is moved towards or to the detection position e.g. by pushing the finger forward.

As described above, the connection completion of the connector 10 and the mating connector can be detected by a movement of the detecting member 50 to the detection position.

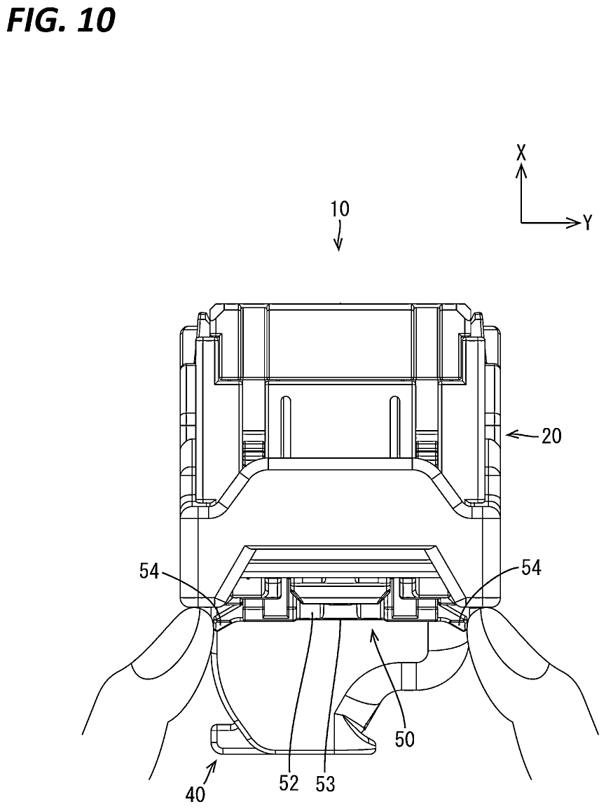

Further, in moving the detecting member 50 from the detection position to the standby position, fingers particularly can be hooked on the protruding portions 54 as shown in FIG. 10, more particularly the pair of protruding portions 54 can be pinched with an index finger and a thumb. Thus, an operation of pulling out the detecting member 50 is facilitated.

### Functions and Effects of Embodiment

(1) The connector 10 of the present disclosure particularly is provided with the housing 20, the detecting member 50 including the push-in portion 52 and/or movable from the standby position to the detection position with respect to the housing 20 by the operating portion (e.g. the push-in portion) 52 being displaced (e.g. pushed in) substantially forward, and the cover 40 mounted on (particularly the rear end part) of the housing 20, wherein the cover 40 particularly includes the one or more cover lock portions 41. Specifically, the vertical portion 42 is provided on (particularly the rear end of) the cover lock portion 41 and the tapered portion 43 is continuous from the vertical portion 42. the rear end of the detecting member 50 at the standby position particularly is disposed at the position behind the vertical portion 42 and/or along the tapered portion 43.

In pushing the detecting member 50 from the standby position to the detection position, a finger particularly can be brought into contact with (e.g. the rear end of) the detecting member 50 particularly by placing the finger on the tapered portion 43 of the cover 40 and moving the finger along the tapered portion 43.

Once the finger particularly contacts the rear end of the detecting member 50, the finger can be moved to the push-in portion by sliding the finger from there. By doing so, the position of the detecting member 50 can be correctly grasped and the push-in portion 52 can be displaced (e.g. pushed in) substantially forward, for example, in an environment where the connector 10 cannot be directly seen by the eyes.

Thus, the operability of the detecting member 50 and overall of the connector can be improved.

(2) Particularly, the detecting member 50 includes the one or more detection arms 51 and/or the operating portion (e.g. the push-in portion) 52 particularly connected thereto (e.g. coupled to the rear end parts of the detection arms 51) and having the push-in surface 53. Specifically, the push-in enlarged surface 55 substantially continuous with the push-in surface 53 is formed on the corner part facing the tapered portion 43, out of the operating portion (e.g. the push-in portion) 52.

Since the finger particularly contacts the push-in enlarged surface 55 if being moved along the tapered portion 43, the finger easily contacts the detecting member 50.

Thereafter, the detecting member 50 can be displaced (e.g. pushed in) forward by moving the finger from the push-in enlarged surface 55 to the push-in surface 53.

(3) Further particularly, the operating portion (e.g. the push-in portion) 52 has a long or oblong shape in a width direction, and the one or more, particularly pair of protruding portions 54 are formed to obliquely extend further rearward than the push-in surface 53 on or near one or both end parts in the width direction of the operating portion (push-in portion) 52.

Since fingers can be hooked on the protruding portion(s) 54 in displacing (e.g. pulling out) the detecting member 50 from the detection position to the standby position, the operation of pulling out the detecting member 50 can be easily performed.

Accordingly, to improve the operability of a detecting member, a connector 10 is provided with a housing 20, a detecting member 50 displaceable or pushable forward from a standby position to a detection position, and a cover 40 mounted on a rear end part of the housing 20. The cover 40 includes at least one cover lock portion 41, a vertical portion 42 provided on a rear end of the cover lock portion 41 and a tapered portion 43 continuous from the vertical portion 42. A rear end of the detecting member 50 at the standby position particularly is disposed at a position behind the vertical portion 42 and along the tapered portion 43.

### Other Embodiments

The above embodiment can be modified and carried out as follows. The above embodiment and the following modifications can be carried out in combination without technically contradicting each other.
Although the push-in enlarged surface 55 particularly is formed on both the push-in portion 52 and the protruding portions 54 in the above embodiment, a push-in enlarged surface may be formed only on the push-in portion 52.
Although the pair of protruding portions 54 particularly are formed on the both end parts in the lateral direction of the push-in portion 52 in the above embodiment, a protruding portion may be formed only on either one of the end parts.
Although the connector 10 particularly provided with the lever 60 is illustrated in the above embodiment, a connector may not be provided with the lever 60.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing;
a detecting member including a operating portion, the detecting member being movable from a standby position to a detection position with respect to the housing by the operating portion being displaced substantially forward; and
a cover to be mounted the housing,
the cover including at least one cover lock portion, a vertical portion provided on a distal end of the cover lock portion and a tapered portion substantially continuous from the vertical portion, and
a rear end of the detecting member at the standby position being disposed at a position behind the vertical portion and substantially along the tapered portion.

2. The connector according to claim 1, wherein:
the detecting member includes at least one detection arm and the operating portion coupled to a rear end part of the detection arm, the operating portion having at least one push-in surface.

3. The connector according to claim 2, wherein at least one push-in enlarged surface substantially continuous with the push-in surface is formed on or near a corner part substantially facing the tapered portion, out of the operating portion.

4. The connector according to claim 2, wherein the operating portion has an oblong shape in a width direction, and a pair of protruding portions are formed to obliquely extend further rearward than the push-in surface on or near both end parts in the width direction of the operating portion.

5. The connector according to claim 2, wherein at least one locking projection is formed at a position at or near a front end part of the detection arm engageable with at least one locking portion of the housing, so that the detecting member particularly is held at the standby position and a movement thereof to the detection position is suppressed.

6. The connector according to claim 5, wherein the detection arm comprises at least one temporary locking portion displaced from the locking projection on the detection arm so as to be lockable to at least one temporary locking projection of the housing, so that the detecting member particularly is holdable at the standby position while being prevented from being displaced away from the housing.

7. The connector according to claim 1, further comprising a movable member movably arranged on the housing between an initial position and a completion position so as to display a cam action for assisting a connection and/or separation of the connector and a mating connector.

8. The connector according to claim 7, wherein the housing comprises a lock arm movably provided thereon, wherein the lock arm has at least one lock receiving portion lockable to at least one lock portion of the movable member so as to hold the movable member at the completion position.

9. The connector according to claim 8, wherein the lock arm includes a base end portion connected to a housing body portion of the housing, an arm portion substantially extending rearward from the base end portion and the at least one lock receiving portion formed on or near a rear end part of the arm portion.

10. A connector assembly comprising a connector according to claim 1 and a mating connector connectable therewith.
